(19) United States
(12) Patent Application Publication
(10) Pub. No.: US 2012/0266978 A1
(43) Pub. Date: Oct. 25, 2012

(54) PRESSURE REGULATOR FOR IRRIGATION PLANT AND IRRIGATION PLANT COMPRISING THE REGULATOR

(76) Inventor: Arno DRECHSEL, Lienz (AT)

(21) Appl. No.: 13/273,979

(22) Filed: Oct. 14, 2011

(30) Foreign Application Priority Data
Oct. 18, 2010 (IT) VI2010A000282

(51) Int. Cl. F16K 21/04

(52) U.S. Cl. 137/511

(57) ABSTRACT

A pressure regulator for irrigation plants comprises a main body (2) with a primary circuit (3) for the flow of an irrigation liquid, a shut-off element (6) operatively associated with the primary circuit (3) and designed to move between a first and a second working end conditions corresponding, respectively, to the minimum and maximum values of the flow rate from the primary circuit (3), regulation means (10) associated with said shut-off element (6) to move it in any regulation working condition between and/or corresponding to said first and second end conditions. The regulation means (10) comprise a secondary circuit (11) fluidically insulated with respect of said primary circuit (3) and designed to contain a working fluid adapted to apply pressure on said shut-off element (6) and adjusting its regulation condition.

### FIELD OF THE INVENTION

The present invention generally finds application in the field of irrigation devices, and particularly relates to a pressure regulator, particularly of electronic type, which is adapted to regulate the delivery pressure of a fluid upstream from a sprinkler of an irrigation circuit.

The invention further relates to an irrigation plant comprising a plurality of pressure regulators as mentioned above.

### BACKGROUND ART

Control of liquid supply pressure in an irrigation system is a step of utmost importance, to constantly ensure proper water supply, and avoid both water waste and insufficient liquid supply.

For this purpose, special pressure or flow regulators are provided at the ends of the delivery pipes, upstream from a corresponding sprinkler that appropriately delivers the flow to the ground.

The task of regulators is to maintain a constant liquid outflow pressure, for the latter to be substantially unaffected by any pressure bursts in the supply line, and particularly the so-called “water hammers”.

The most widely used flow or pressure regulators are generally of mechanical type. Typically, such regulators have a main body with a central circuit or pipe, open at its ends, for the passage of irrigation liquid.

The regulator further includes a nozzle mounted at the outlet of the pipe and an irrigation water pressure-regulating chamber located directly upstream from the nozzle, in which the inflow supply pressure is measured.

Pressure is regulated by a shut-off element sliding in the main body and adapted to change the inlet port of the pipe according to the measured value.

The regulating movement of the shut-off element is generated by pressure of the regulated fluid itself, so that as the supply pressure increases the liquid inflow port is proportionally closed.

These prior art regulators have the advantage of being relatively simple and inexpensive to manufacture.

Nevertheless, they often fail to provide the required regulation accuracy, due both to their inherent mechanical nature, which does not allow accurate control of movements in the shut-off element and to normal friction or impurities that might alter their operation.

Furthermore, the use of mechanical regulators imparts poor versatility to the irrigation line, because soil areas having different irrigation requirements cannot be treated in different manners.

A further drawback is the impossibility of controlling the flow from each regulator according to the characteristics or requirements of the soil portion irrigated by a particular regulator.

Therefore, periodic replacement of nozzles may be required, particularly if supply requirements change in the soil area served by a particular sprinkler.

An additional detrimental effect of this type of regulators is that, to ensure well-defined outflows, the diameter of the nozzles along the delivery line has to be frequently changed.

Therefore, different types of nozzles shall be provided with diameters falling within a relatively wide range, which will increase management and storage costs.

In an attempt to at least partially obviate the above drawbacks, electronically controlled pressure regulators have been developed, in which the shut-off element is controlled by an electronically managed actuator, which is connected to an electronic pressure sensor that measures pressure upstream from the nozzle and downstream from the nozzle throat.

Thus, the sensor transmits a signal to the actuator, which accordingly acts upon the shut-off element.

One example of a similar electronic regulator is known, amongst others, from U.S. Pat. No. 6,892,900, by the Applicant hereof, and comprises a central liquid flow pipe having elastic side walls.

The shut-off element is located outside the pipe and is connected to a lever actuator, driven by an electronically controlled linear motor, and connected to a pressure sensor.

The operation of the lever actuator causes controlled translation of the shut-off element, with the central pipe being throttled to a corresponding extent.

While this regulator provides greater versatility and delivery stability, it still has a relatively complex construction and an inconstant reliability, due to the presence of the lever-operated control mechanism, and is not always easily mounted to the main supply line.

Furthermore, the action of the shut-off element from outside the pipe may lead with time to changes in the behavior of the regulator.

Finally, the actuator requires high power, which will increase power consumption.

### DISCLOSURE OF THE INVENTION

The object of the present invention is to overcome the above drawbacks, by providing a pressure regulator for irrigation plants that achieves high efficiency and relative cost effectiveness.

A particular object is to provide a pressure regulator that ensures high accuracy and affords easy and simple installation, to provide a reliable and constant behavior with time.

A further object is to provide a pressure regulator of electronic type having high reliability and requiring a considerably lower power supply.

Yet another object is to provide an electronic pressure regulator that can adapt the outflow characteristics to the particular requirements of each soil or cultivation portion to be irrigated.

A further object is to provide an electronic pressure regulator that can use nozzles having outlet diameters selected from a relatively narrow range of values, i.e. a relatively limited set of values, to simplify spare part management and can deliver at pressures falling in a wide range of values.

Yet another object is to provide an irrigation plant that ensures an optimal pressure for each regulator, by adapting it to the particular requirements of each soil or cultivation portion to be sprinkled by each regulator.

These and other objects, as better explained below, are fulfilled by a pressure regulator as defined in claim 1, which comprises a main body with a primary circuit for the passage of an irrigation liquid, with an inlet port designed to be connected to a liquid supply line and an outlet port for liquid delivery, a shut-off element operatively associated to the primary circuit and designed to move between a first and a second working end conditions corresponding, respectively, to the minimum and maximum values of the flow rate from said outlet port.

Regulation means are further provided, which are associated with said shut-off element to move it to a regulation working condition corresponding to or between said first and second limit conditions.

The regulator is characterized in that the regulation means comprise a secondary circuit fluidically insulated with respect to said primary circuit and designed to contain a working fluid adapted to apply a pressure on said shut-off element and adjust its regulation condition.

This particular configuration will afford a more accurate control of the working condition of the shut-off element and, as a result, the pressure at its outlet.

In a further aspect, the invention relates to an irrigation plant as defined in claim 11.

In a particular aspect, the plant may comprise an electronic central control unit, which is adapted to receive the pressure values measured at the outlet of each electronic regulator and to transmit respective controls thereto to adjust the working condition of the corresponding shut-off elements independently of one another.

This will allow both maintenance of a constant pressure at each regulator and adaptation of pressure, according to the nozzle size, to the special requirements of the soil or cultivation area served by each regulator, without replacing the nozzles as the delivery requirements change.

Advantageous embodiments of the invention are defined in accordance with the dependent claims.

### BRIEF DESCRIPTION OF THE DRAWINGS

Further features and advantages of the invention will be more apparent upon reading the detailed description of a few preferred, non-exclusive embodiments of an electronic flow regulator for irrigation plants of the invention, which are described as non-limiting examples with the help of the annexed drawings, in which:

FIG. 1 is a perspective view of a regulator of the invention according to a first preferred embodiment;

FIG. 2 is a perspective sectional view of the regulator of FIG. 1, with the shut-off element in the first limit working condition;

FIG. 3 is a sectional front view of the regulator of FIG. 1 in the working condition of FIG. 2;

FIG. 4 is a front sectional view of the regulator of FIG. 1, with the shut-off element in an intermediate working condition;

FIG. 5 is a front sectional view of the regulator of FIG. 1, with the shut-off element in the second limit working condition;

FIG. 6 is a perspective view of a regulator of the invention according to a second preferred embodiment;

FIG. 7 is a perspective sectional view of the regulator of FIG. 6, with the shut-off element in the first limit working condition;

FIG. 8 is a sectional front view of the regulator of FIG. 6 in the working condition of FIG. 7;

FIG. 9 is a front sectional view of the regulator of FIG. 6, with the shut-off element in an intermediate working condition;

FIG. 10 is a front sectional view of the regulator of FIG. 6, with the shut-off element in the second limit working condition.

### DETAILED DESCRIPTION OF A PREFERRED EMBODIMENT

Referring to the above figures, the regulator of the invention, generally designated by numeral 1, may be used in an irrigation plant, not shown, at one outlet thereof.

The regulator 1 may be installed both in fixed and “center pivot” irrigation plants, without requiring particular changes for adaptation to the characteristics of each particular plant.

Particularly, the regulator 1 is designed to be installed upstream from its sprinkler, also not shown and known per se, which may be configured in any manner as is known in the art, and will be designed to receive liquid from the regulator 1 and deliver it to the ground or cultivation to be irrigated.

Reference is made in the annexed figures to an electronic regulator. Nevertheless, in its basic configuration, the regulator 1 of the invention may also be of mechanical type.

According to the invention, a regulator 1 comprises a main body 2 which is designed to be connected to a supply line for an irrigation liquid, typically water, and defines a first longitudinal axis X.

A main circuit is provided in the main body 2, and comprises a liquid flow pipe with an inlet port 4 and an outlet port 5 for such liquid.

Furthermore, a shut-off element 6 is provided, which is operatively associated with the pipe 3 to move between a first and a second limit working conditions corresponding, respectively, to the minimum and maximum values of the flow rate from the pipe 3.

For instance, the pipe 3 may have an intermediate section 7 between the two axial end ports 4, 5 which may have a predetermined regulating cross section 8, as shown by broken lines in FIGS. 3, 4, 8 and 9.

The shut-off element 6 may be located at the intermediate section 7 of the pipe 3 to move between first and second end conditions, corresponding to minimum and maximum values of the passage section 8 of the pipe 3.

For instance, as shown in the figures, the shut-off element 6 may be held in the pipe 3, at the intermediate section 7.

Nevertheless, the shut-off element 6 may be also placed outside the pipe 3, i.e. next to the outlet port 5 or still within the pipe 3, but next to the inlet port 4 to change its size.

A nozzle, not shown, whose diameter is selected according to the flow to be delivered is installed, preferably in a removable manner, at the outlet port 5.

The regulator 1 also comprises regulation means, generally referenced 10, preferably of electronic or electromechanical type, which are associated with the shut-off element 6 to move it to any regulation working condition between or corresponding to the limit conditions.

For example, if the shut-off element 6 is within the pipe 3, the regulation means 10 will cause the passage section 8 to change between a maximum value and a minimum value.

The regulation condition may either correspond to any working condition between the end conditions, or coincide with either one of the latter.

In a peculiar aspect of the invention, the regulation means 10 include a secondary regulation circuit 11, which is fluidically insulated from the main circuit or passage pipe 3.

Preferably, the regulation circuit 11 is closed and contained in the main body 2.

The regulation circuit 11 contains a working fluid and is operably associated with the shut-off element 6 to apply thereon a variable regulation pressure to move it to the predetermined regulation condition and hold it therein.

In a particular configuration, the regulation circuit 11 comprises first and second chambers, both having a variable volume, referenced 13 and 14 respectively, which are fluidically connected to each other.

Furthermore, the second chamber 14 is associated with the shut-off element 6, so that any change of its inner pressure will cause a thrust thereon which changes its working condition.

Advantageously, the regulation means 10 include an actuator 12 operatively associated with the shut-off element 6.

The actuator 12 is movable in the first chamber 13 to change the volume thereof and change, as a result, the amount of fluid in the second chamber 14, while changing its volume, to move the shut-off element 6 into the regulation working condition.

For this purpose, any fluid, either liquid or gas, may be used, although water would be preferred and a mineral oil, e.g. silicone oil having a low freezing point and a relatively low compressibility would be even more preferred.

This will allow volume changes in the first chamber 13 to coincide as much as possible with those in the second chamber 14, for accurate and constant regulation.

Advantageously, the shut-off element 6 comprises an expandable outer portion 15 which is made of an elastomeric material and delimits the second chamber 14.

The elastomeric portion 15 also has a working fluid inlet 16 in fluid communication with the first chamber 13.

In this particularly preferred, non-limiting configuration of the invention, if the shut-off element 6 is within the pipe 3, its first end condition, corresponding to the maximum size of the passage section 8, will correspond to the minimum volume condition of the second chamber 14. This condition is shown in FIGS. 2 and 3 and in FIGS. 7 and 8.

On the other hand, the second end condition of the shut-off element 6, corresponding to the minimum size of the passage section 8, as shown in FIGS. 5 and 10, corresponds to the maximum volume condition of the second chamber 14.

This condition may correspond, for instance, to a fully obstructed cross section 8, with substantially no outflow. This, the regulator 1 may be also used as an ON/OFF valve.

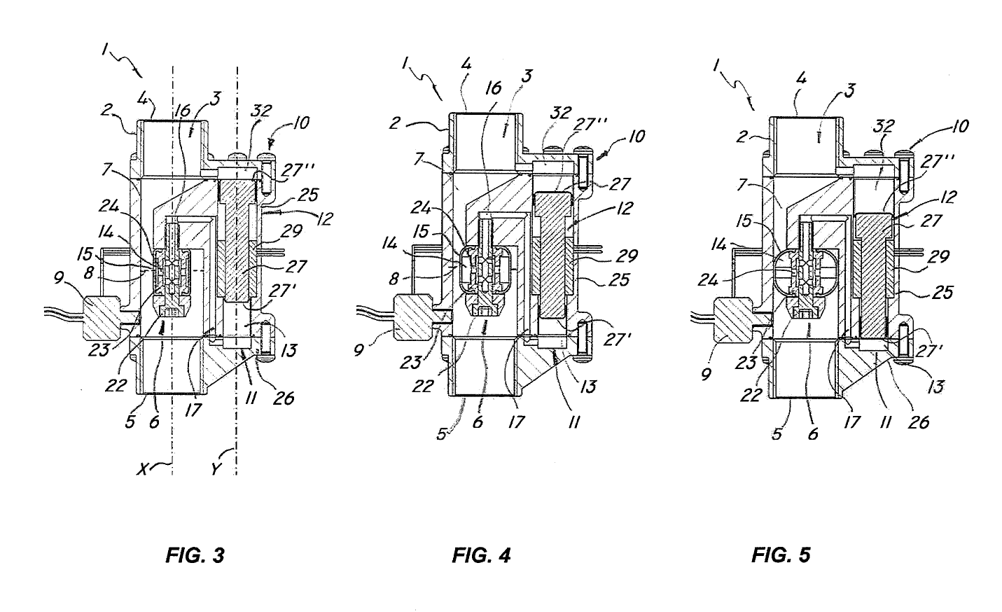

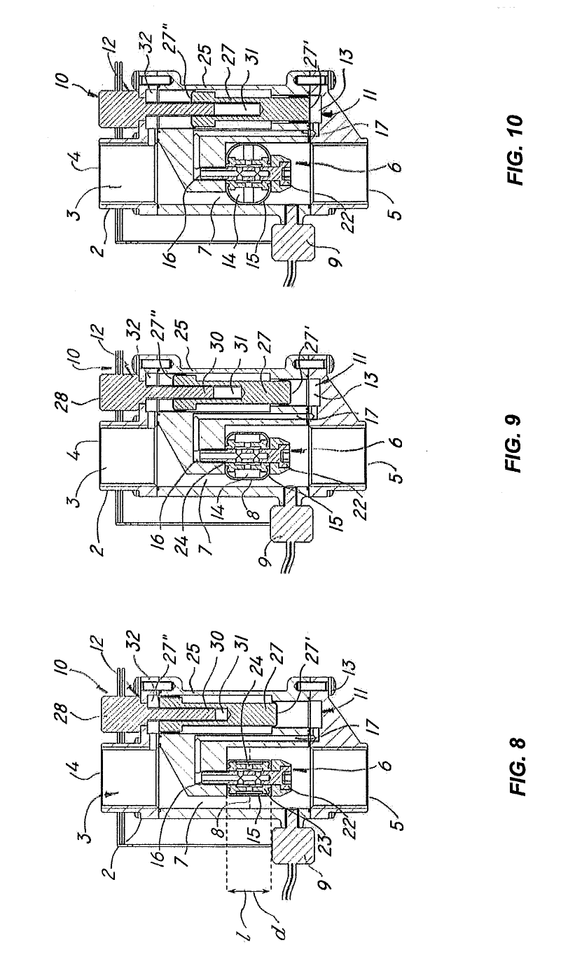

A possible configuration of the shut-off element 6 in an intermediate regulation condition between the two end conditions is shown in FIGS. 4 and 9.

In this peculiar configuration, the pipe 3 is substantially cylindrical and the shut-off element 6 has a substantially constant maximum axial dimension d throughout its working conditions.

Such axial dimension d also defines the axial length l of the intermediate section 7 of the pipe 3, any cross section 8 thereof thus having a substantially annular shape.

However, it shall be understood that different solutions may be also envisaged for the shut-off element 6, which may be located, for instance, in a non-illustrated configuration, outside the pipe 2, the latter being in turn at least partially resilient, as substantially equivalent to what is disclosed in the above mentioned U.S. Pat. No. 6,892,900.

As shown by the sectional views, the regulation circuit 11 includes a channel 17 for connection between the two chambers 13, 14.

Particularly, in an advantageous embodiment, the channel 17 may be at least partially formed directly in the material of the main body 2 and terminate in a stationary element 22 which is held within the second chamber 14, to secure the shut-off element 6 to the main body 2.

Preferably, the end section of the channel 17 has a plurality of outlet ports within the second chamber 14, four ports in the illustrated configurations, to allow uniform elastic deformation of the expandable portion 15.

Furthermore, a further cylindrical element 23 external to and coaxial with the anchor element 22 may be provided in the second chamber 14, for fixing the elastomeric portion 15. The cylindrical element 23 has additional outlet passages 24 for damping flow and providing a more accurate control of the elastic deformation of the shut-off element 6.

The actuator 12 is slideably held in a substantially cylindrical sleeve 25 which is formed in a lateral portion 26 of the main body 2 and contains the first chamber 13.

The cylindrical sleeve 25 may be also formed in a portion of the regulator 1 separated from the main body 2. Nevertheless, the above configuration will provide a compact, easy-to-install regulator 1.

The sleeve 25 also defines a second longitudinal axis Y, preferably but without limitation parallel to the first axis X, with the actuator 12 being translatably accommodated therein.

The latter will include or consist of a piston 27 which axially and tightly slides in the cylindrical sleeve 25 and has a first axial end 27′ in the first chamber 13 to change the volume thereof upon translation.

The actuator 12 comprises an electric motor 28 associated with the piston 27, and adapted to be actuated by an external control to cause the piston 27 to move in the cylindrical sleeve 25.

The electric motor 28 may be any motor that can move the piston 27 and may be selected, by way of example, from the group comprising stepper motors, induction motors and the like.

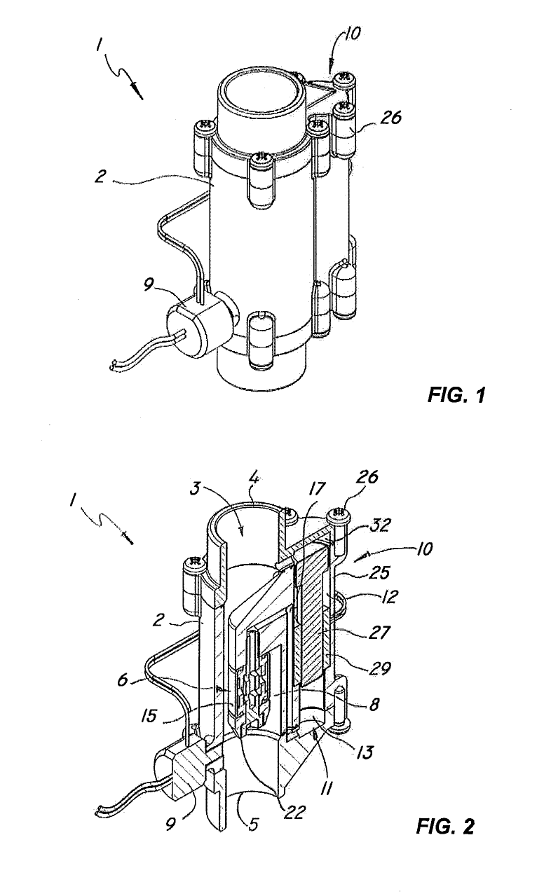

For example, in the configuration as shown in FIGS. 1 to 5, the electric motor 27 comprises a winding 29, which is held within the chamber 25 on the periphery of and coaxial with the piston 27.

The winding is designed to generate an electromagnetic field of predetermined intensity, susceptible of causing an axial translation of the piston 27.

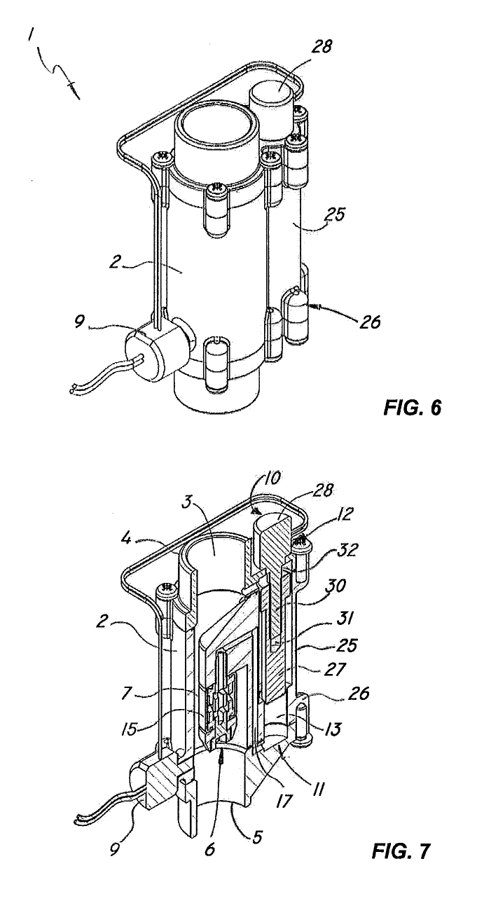

In the configuration of FIGS. 6 to 10, the electric motor 27 is a stepper motor.

Particularly, the motor 27 comprises a worm 30 rotatably inserted in an axial cavity 31 in the piston 27.

The worm 30 has a threaded inner surface, for its rotation to cause a controlled translation of the piston 27.

In both configurations, the piston 27 has a second axial end 27″, which delimits a third variable-volume chamber in the cylindrical sleeve 25, which chamber is fluidically connected to the inlet port 4 of the pipe 3.

Preferably, the third chamber 32 is formed on the side opposite to the piston 27, at the second axial end 27″ of the latter.

The third chamber 32 may receive part of the irrigation liquid flow, at the supply pressure in the pipe to assist the operation of the piston 27 by applying an auxiliary pressure on its second end 27″ to cause axial translation thereof.

This will reduce energy consumption, and the power supply required for moving the actuator 12.

However, the regulation circuit 11 may also be fluidically disconnected from the liquid flow pipe 3.

On the other hand, in an alternative configuration, not shown, the actuator 12 may not be equipped with the driving motor 28 and may be simply moved by the pressure of liquid flowing into the circuit 11. While this configuration provides a lower level of accuracy, it has the advantage of having a lower cost and a simpler construction.

In a particularly advantageous aspect of the invention, the regulation means 10 may comprise an electronic sensor 9 located close to the outlet port 5, which is adapted to measure a liquid pressure value at the port 5 to convert it into a corresponding electric or electronic control signal.

For this purpose, the pressure sensor 9 is electronically connected to the actuator 12, and the regulation means 10 are designed to receive the control signal from the sensor 9 and actuate the actuator 12 to move the shut-off element 6 to the regulation condition that corresponds to the measured pressure.

The regulation means 10 also include an electronic control unit, not shown, which is connected to the sensor 9 to receive the electronic input signal and process it to generate an actuation control for the actuator 12.

The connection between the sensor 9 and the control unit, and between the sensor 9 and the actuator 12 may be either a wired or a wireless connection.

In operation, the irrigation liquid enters the main circuit 3 through the inlet port 4 and flows towards the outlet port 5, where the sensor 9 detects the liquid pressure value and sends an electric signal to the electronic control unit.

The latter has the regulation pressure value required to obtain the desired outflow, stored therein.

Therefore, the control unit compares the measured value with the desired value and, if needed, drives the actuator 12 to move the shut-off element 6 to a working condition in which the two pressure values match.

In a further aspect, the invention relates to an irrigation plant, not shown, comprising an irrigation liquid supply line which is designed to be connected at one end to a water supply system and has a plurality of liquid delivery outlets.

Therefore, the supply line has a plurality of flow regulators 1 as described above, each being preferably removably connected to a corresponding outlet of the line to put the corresponding inlet port 4 in fluid communication with such outlet.

The plant may also comprise a plurality of sprinklers, not shown, located downstream from the nozzles of respective flow regulators 1.

In a particularly advantageous aspect of the invention, the plant comprises an electronic central control unit, which is susceptible of receiving the pressure values measured at the outlet by the sensors 9 of each regulator 1 and to transmit respective controls to the actuators 12 to adjust the working condition of the corresponding shut-off elements 6 independently of one another. This will allow accurate metering of the amount of liquid, generally water, delivered to the ground for each portion thereof.

For this purpose, the plant may comprise a plurality of monitoring devices which are designed to detect one or more physical parameters of to the soil and/or cultivation portion located at respective regulators 1 and to send respective data to the central control unit for independent metering of the individual flows from the regulators 1.

This particular configuration allows adaptation of irrigation profiles, by controlling the outflow from each regulator 1 according to the requirements of each soil or cultivation portion served by the particular regulator 1, possibly by excluding one or more regulators 1.

The central control unit may be integrated in the general control system of the plant, for simplified and optimized management thereof.

Advantageously, the control unit is also designed to detect the available flow at the inlet of the line, determine the flow required for each outlet and accordingly control the pressure in each regulator 1.

Also, it can measure the pressure value available at the line inlet to check whether minimum requirements for feeding the regulators 1 are fulfilled.

The above disclosure clearly shows that the invention fulfills the intended objects, and particularly meets the requirement of providing a pressure regulator, particularly of electronic type, for irrigation systems, that allows highly accurate and adaptable regulation of the desired outflow, for each soil portion to be irrigated.

The possibility of regulating each outflow pressure independently and with the highest accuracy can avoid the use of nozzles having diameters selected from relatively wide sets or ranges of values.

Particularly, a smaller number of different nozzle outlet diameters may be used, e.g. 4 or 5, also for very long lines, unlike traditional lines which use a different diameter every three outlets.

Furthermore, repeated replacement of nozzles is no longer required if different flow and/or pressure conditions occur upstream from the supply line or, in case of “center pivot” plants, if rotation speeds change in the line.

Likewise, nozzle replacement is not required if the use of the plant changes from linear system to center pivot, or vice versa.

The regulator and plant of the invention are susceptible to a number of changes or variants, within the inventive concept disclosed in the appended claims. All the details thereof may be replaced by other technically equivalent parts, and the materials may vary depending on different needs, without departure from the scope of the invention.

While the regulator and plant have been described with particular reference to the accompanying figures, the numerals referred to in the disclosure and claims are only used for the sake of a better intelligibility of the invention and shall not be intended to limit the claimed scope in any manner.

1. A pressure regulator for irrigation plant, comprising:
a main body comprising a primary circuit for the passage of an irrigation liquid having an inlet port connectable to a feeding line for said liquid and an outlet port for supplying said liquid;
a shuttering element operatively associated to said primary circuit and designed for moving between a first and a second working end conditions corresponding, respectively, to the minimum and maximum values of the flow rate from said outlet port;
regulation means associated to said shuttering element to bring it in any regulation working condition between and/or corresponding to said first and second end conditions;
wherein said regulation means comprise a secondary circuit fluidically insulated with respect of said primary circuit and designed for containing a working fluid adapted to apply a pressure on said shuttering element and adjusting its regulation condition.

2. The regulator according to claim 1, wherein said secondary circuit is closed and comprises a first and a second variable volume chamber in reciprocal fluidic connection, said second chamber being operatively associated to said shuttering element.

3. The regulator according to claim 2, wherein said regulation means comprise an actuator movable into said first chamber for adjusting the flow amount into said second chamber and bring said shuttering element into said regulation condition.

4. The regulator according to claim 3, wherein said actuator comprises a substantially cylindrical jacket wherein a piston is slidably housed in a sealed manner, said piston having a first axial end delimiting said first chamber.

5. The regulator according to claim 4, wherein said actuator comprises an electric motor associated to said piston for promoting the axial sliding thereof into said jacket and adjusting the volume of said first chamber.

6. The regulator according to claim 5, wherein said electric motor comprises a winding housed into said jacket peripherally and coaxially to said piston and designed to generate an electromagnetic field with a predetermined intensity designed for determining said axial sliding of said piston.

7. The regulator according to claim 2, wherein said shuttering element is internally placed into said primary circuit and comprises an expansible portion made of an elastomeric material which encloses said second variable volume chamber, said expansible portion having an inlet for said working fluid in fluidic connection with said first chamber.

8. The regulator according to claim 4 wherein said piston has a second axial end delimiting into said cylindrical jacket a third variable volume chamber fluidically connected with said inlet port for receiving part of the irrigation liquid and applying on said second end an auxiliary pressure adapted to assist the functioning of said piston.

9. The regulator according to claim 1, wherein said regulation means comprise a pressure sensor placed close to said outlet port for measuring a pressure value of the liquid at the same.

10. The regulator according to claim 9, wherein said sensor is of the electronic type for transducing said measured pressure value in an electric signal, said regulation means further comprising an electronic control unit operatively connected to said sensor for receiving and treating said electric signal and sending an actuating command to said actuator.

11. An irrigation plant, comprising:
at least one feeding line for an irrigation liquid having at least one inlet opening connectable to a water supply net and a plurality of outlet openings for the liquid;
a plurality of pressure regulators as claimed in one or more of the preceding claims and each having a main body with a primary circuit for the passage of said liquid with an inlet port connected to a respective outlet opening of said line and a respective outlet port for said liquid.

12. The plant according to claim 11, wherein each of said pressure regulators comprises regulation means having a respective actuator operatively associated to a corresponding shuttering element and a respective electronic sensor designed to measure a pressure value for the liquid at a respective outlet port and to transduce it in a corresponding electric signal, a central electronic control unit being also provided which is designed for receiving the electric signal coming form each of said regulators and sending respective commands to corresponding actuators for adjusting the working conditions of the corresponding shuttering elements independently each other.

13. The plant according to claim 12, comprising a plurality of monitoring device designed to detect one or more physical parameters with respect to the soil and/or cultivation portion placed at a respective regulators of said plurality and sending respective data to said centralized control unit for the independent dosing of the single flows outcoming from said regulators.
